(19) United States
(12) Patent Application Publication
(10) Pub. No.: US 2005/0148339 A1
(43) Pub. Date: Jul. 7, 2005

(54) Personal item monitor using radio frequency identification

(76) Inventors: Robert C. Boman, Thousand Oaks, CA (US); Brian Hanson, Goleta, CA (US)

Correspondence Address: HARNESS, DICKEY & PIERCE, P.L.C., P.O. BOX 828, BLOOMFIELD HILLS, MI, 48303, US

(21) Appl. No.: 10/751,851

(22) Filed: Jan. 6, 2004

(51) Int. Cl. H04Q 7/20

(52) U.S. Cl. 455/456.1

(57) ABSTRACT

A personal item monitoring system includes a monitor having a transmitter and a receiver located therein. At least one radio identification tag is adapted to be coupled to a personal item. Alternatively, the radio identification tag may be pre-installed into the personal item. The monitor emits a radio frequency received by the radio frequency identification tag, and the radio frequency identification tag emits a responding signal if within a detection range. The monitor then alerts a user if the radio identification tag leaves the range of detection.

### FIELD OF THE INVENTION

The present invention relates to electronically monitoring the location of personal items, and more particularly to a personal item monitor using radio frequency identification to electronically monitor the location of personal items.

### BACKGROUND OF THE INVENTION

It is common for people to carry small objects on their person such as, for example, keys, wallets, cellular phones, PDAs, purses, and glasses. Unfortunately, due to their small size, it is not uncommon for these personal items to be misplaced. If these objects are lost or stolen, it is at best very inconvenient and at worst financially destructive. Accordingly, a system which automatically warns the user when a personal item carried on the person is missing would be very useful.

Currently, there are some products that exist that attempt to address this issue. For example, one such product includes a transmitter and receiver. The receiver is carried with the user and the transmitter is placed in the user's personal item, typically a purse. When the transmitter is moved more than certain distance away from the receiver, the receiver sounds an alarm, thus indicating that the purse or other large item has been left behind. However, there are several limitations to these devices. For example, the transmitter is much too large to monitor small devices such as keys, wallets, or glasses. Moreover, both the transmitter and the receiver must use battery power at each end for the system to operate (and batteries are relatively bulky and periodically require replacement). If the user fails to carry the receiver, the system is useless. Finally, both the receiver and the transmitter must be turned on for each use.

With the above limitations of the current technology in mind, there is room in the art for a personal item monitor that overcomes these limitations.

### SUMMARY OF THE INVENTION

A personal item monitoring system includes a monitor having a transmitter and a receiver located therein. At least one radio frequency identification tag is adapted to be coupled to a personal item. Alternatively, the radio identification tag may be preinstalled into the item. The monitor emits a radio frequency received by the radio frequency identification tag, and the radio frequency identification tag emits a responding signal if within a detection range. The monitor then alerts a user if the radio identification tag leaves the range of detection.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an exemplary illustrative view of a personal item monitoring system constructed according to the principles of the present invention;

FIG. 2 is a schematic view of the personal item monitoring system of the present invention illustrating a detection field and lost item; and

FIG. 3 is a schematic view of the personal item monitoring system of the present invention.

### DETAILED DESCRIPTION OF THE PREFERRED EMBODIMENTS

The following description of the preferred embodiment(s) is merely exemplary in nature and is in no way intended to limit the invention, its application, or uses.

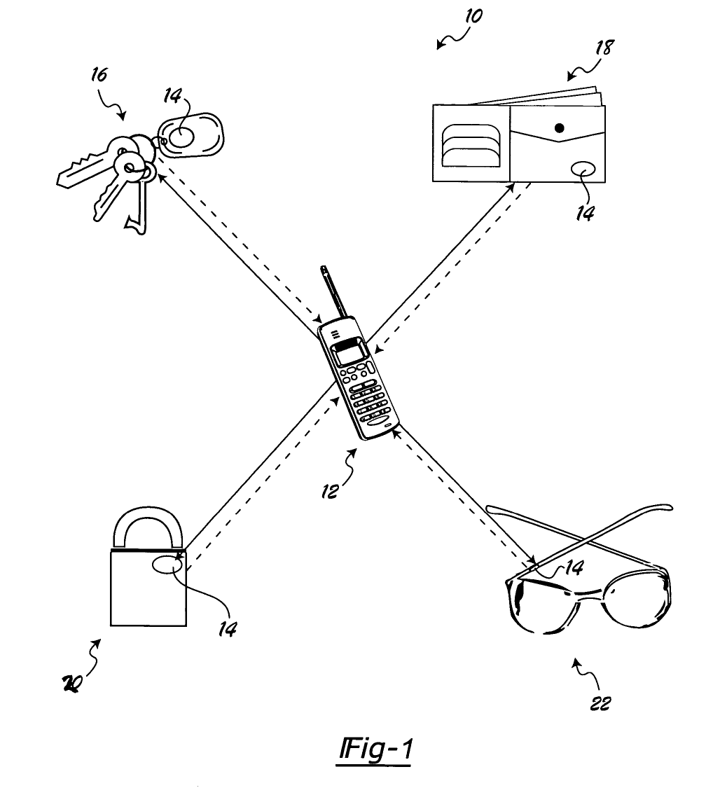

With reference to FIG. 1, a personal item monitoring system (PIMS) is generally indicated by reference numeral 10. The PIMS 10 generally includes a monitor 12 and a plurality of radio frequency identification tags (RFID tags) 14. Used herein, the term “radio frequency identification tag” refers to any device which wirelessly transmits an identification signal in response to a wireless query signal. Additionally, such a device is expected to be small in size and does not require a renewable power source (i.e. a battery that requires periodic replacement). Moreover, in the particular example provided, the monitor 12 is illustrated as a cellular phone. However, it is to be appreciated that various other devices may be used as the monitor 12, for example, a PDA or a dedicated transmitter/receiver. Generally speaking, both RFID tags and cellular telephones use UHF frequencies. In Europe, RFID tags commonly use 868 MHz and in the United States, RFID tags use 915 MHz frequencies. Cellular phones typically use either 800 MHz or 1900 MHz bands, with many cellular phones supporting both. Because the frequencies of typical RFID tags and cellular phones are similar and because cellular phones already have a transmitter/receiver located therein, cellular phones make ideal monitors for housing a built-in RFID reading capability.

The RFID tags 14 of the present invention include a small electronic chip (not shown) with a radio frequency transponder (not shown). Preferably, the RFID tags 14 include an adhesive sticker (which may include a printed logo) having the electronic chip embedded therein. The RFID tags 14 may then be adhesively attached to any number of items, for example, a first item 16, a second item 18, a third item 20, and a fourth item 22. As illustrated in FIG. 1, items 14, 18, 20, 22 are, respectively, keys, a wallet, a purse, and glasses. It should be appreciated, however, that any number and kind of items may be tagged. Alternatively, the RFID tags 14 may be already imbedded in the personal items directly.

The monitor 12 emits a radio signal that is received by the RFID tags 14. The electronic radio frequency transponder located within the RFID tags 14 in turn responds with a returning radio signal. This returning radio signal from the RFID tags 14 is received by the monitor 12.

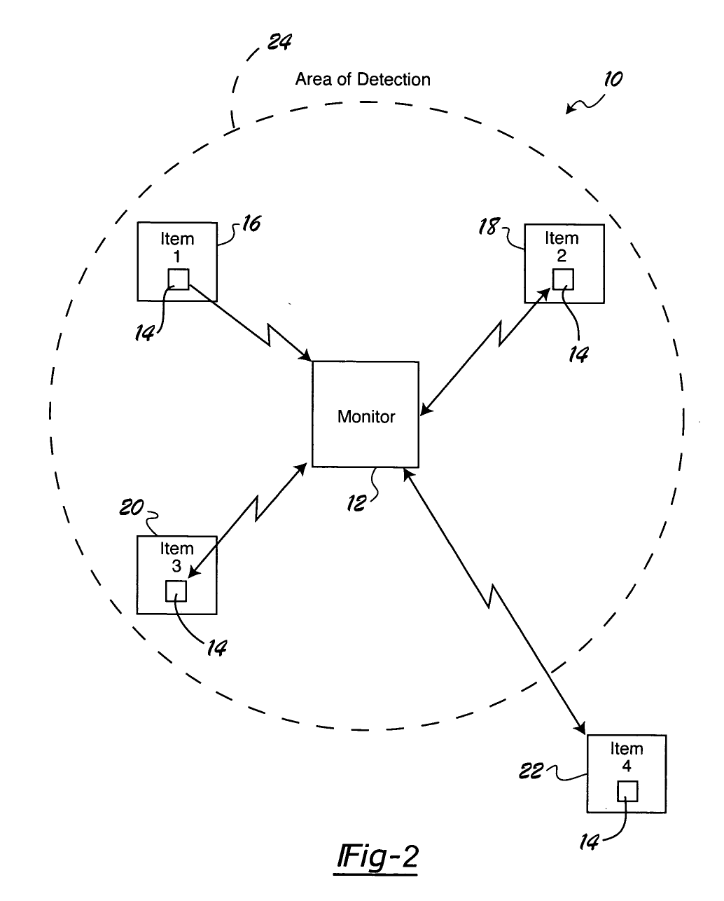

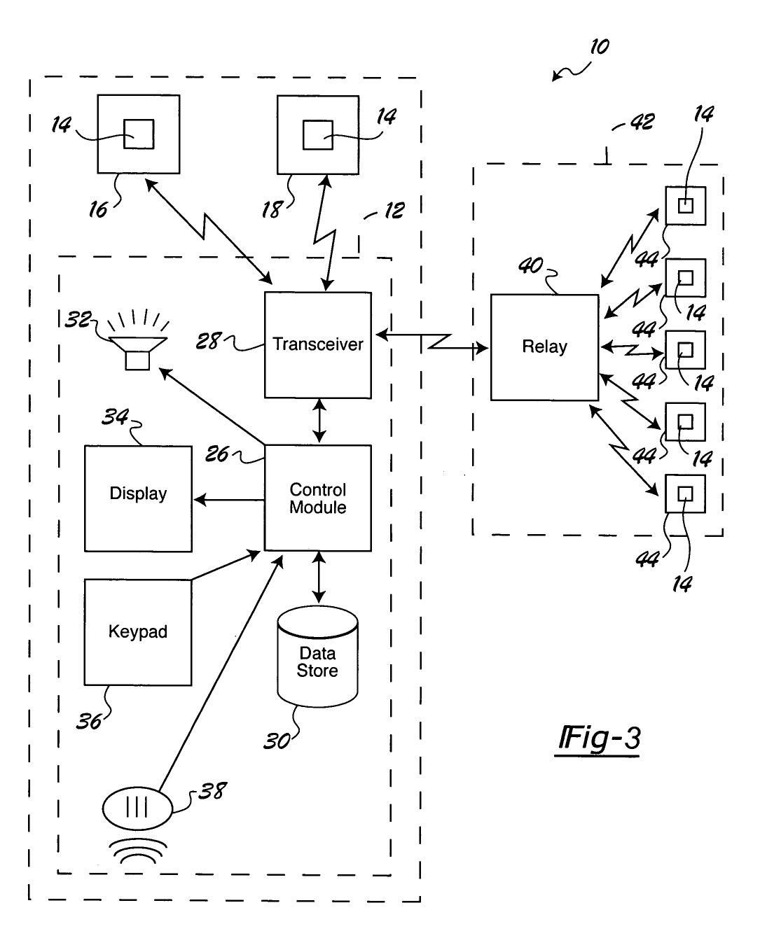

Turning to FIG. 2, the PIMS 10 includes an area of detection indicated by reference numeral 24. The area of detection 24 is a zone of space around the monitor 12 in which the RFID tags 14 may be detected. This area of detection 24 may have a restricted range (e.g., anywhere from 6 meters to 0.5 meters) and is adjustable by the monitor 12. If an item with an attached RFID tag 14, for example item 4 in FIG. 3, leaves the area of detection 24, the monitor 12 will signal an alert, as will be described below.

Turning to FIG. 3, the monitor 12 preferably includes a control module 26 in electronic communication with a transceiver 28 and a data store 30. The control module 26 is an electronic processing unit used to control the PIMS 10. The transceiver 28 is in electronic wireless communication with the RFID tags 14 and receives a return signal therefrom when the RFID tags 14 are within the area of detection 24 (FIG. 2). The data store 30 is a memory device for storing the RFID tags 14 and associated data.

The monitor 12 further includes an audio output 32 (e.g. a speaker), a display device 34 (e.g. a screen), a keypad 36, and an audio input 38 (e.g. a microphone), all in electronic communication with the control module 26.

To enter a specific RFID tag 14 into the PIMS 10, a user enters a menu system (or other software hierarchy) displayed on the display device 34. For each RFID tag 14 within the area of detection 24 (FIG. 2), a corresponding entry appears on the display 34. A user then labels each entry (corresponding to a particular RFID tag 14) using either the keypad 36 or speaking into the audio input 38 and using speech recognition software to label the entries. This data is then stored in the data store 30.

When a particular RFID tag 14 leaves the area of detection 24 (as illustrated in FIG. 2), the transceiver 28 no longer receives an incoming return signal. The control module 28 identifies which particular RFID tag 14 is no longer returning a signal and alerts the user that an item is missing. This alert can include, for example, using speech synthesis software to announce “Your wallet is missing” or by sounding an audio alert signal using the audio output 32.

In the case where the monitor 12 is a cellular phone, the alert may consist of ringing the cellular phone as if a call were present and using speech synthesis to inform the user which item is missing and for how long the item has been missing. This feature can also be used to provide an alert if the cellular phone is stolen, e.g., by making the system call a pre-selected phone number when the cellular phone and RFID tags 14 become separated. Furthermore, to prevent unauthorized usage in such circumstances, the cellular phone could disable itself unless a password is entered.

The PIMS 10 may further include a relay 40. The relay 40 is a remote device having an independent power source and transceiver. The relay 40 is in wireless electronic communication with the transceiver 28 of the monitor 12 and has an area of detection (not shown) similar in use to the area of detection 24 in FIG. 2. However, the range of the relay 40 may be greater or smaller. In the particular example provided, the relay 40 may be placed within a home environment 42 with a plurality of items 44 (such as, for example, televisions, computers, stereos, etc.). Each of the items 44 includes an RFID tag 14. If an RFID tag 14 is removed from the home environment 42 (which in turn preferably corresponds to the area of detection of the relay 40), the relay 40 signals the monitor 12 which particular RFID tag 14 is no longer returning a signal. The monitor 12 may then alert a user using one of the methods described above. In an alternate embodiment, the relay 40 may be shaped like a credit card and placed in a wallet or purse to monitor the items located within the wallet or purse.

In the event of a “reader collision” (e.g. more than one monitor transmitting a signal on the frequency used by the RFID tags 14), the control module 26 preferably includes an algorithm for deactivating the signal from the monitor 12. For example, the transceiver 28 will receive the broadcast signal from another transmitting monitor or other device. The control module 26 will then know the monitor 12 is in a “hot spot” (e.g., an area where a signal using the same frequency as the RFID tags 14 already exists). The control module 26 then suspends the signal from the monitor 12 until such time as the monitor 12 is no longer within the “hot spot”. This feature will prevent “reader collision” and save power during the suspended use.

The user can deactivate monitoring any individual RFID tag 14 in the event that the user is not carrying a particular item by deactivating or removing the item from the monitor 12. Moreover, a clock in the monitor 12 can be programmed to look for a user's item at a certain time, for example, in the morning before leaving the house, such that the user does not forget to take the item with the user. Finally, the PIMS 10 may be used to find lost items that have been tagged with one of the RFID tags 14. By moving the location of the monitor 12, the user can determine if the particular item missing is within the area of detection 26 and the monitor 12 may be programmed to alert the user with an audible noise or using speech synthesis to indicate that the item is nearby. By monitoring the strength of the returning radio signal from the RFID tag 14, the monitor 12 can notify the user whether the user is getting closer or farther away.

The description of the invention is merely exemplary in nature and, thus, variations that do not depart from the gist of the invention are intended to be within the scope of the invention. Such variations are not to be regarded as a departure from the spirit and scope of the invention.

1. A personal item monitoring system comprising:
a monitor having a transmitter and a receiver located therein; and
at least one radio frequency identification tag adapted to be coupled to a personal item;
wherein said monitor emits a radio frequency signal received by said radio frequency identification tag, and said radio frequency identification tag emits a responding signal if within a detection range; and
said monitor alerts a user if said at least one radio frequency identification tag leaves said detection range.

2. The personal item monitoring system of claim 1, wherein said monitor is a cellular phone.

3. The personal item monitoring system of claim 2, wherein said cellular phone is programmed to dial a pre-selected phone number to alert said user when said at least one radio frequency identification tag leaves said detection range.

4. The personal item monitoring system of claim 2, wherein said cellular phone is disabled when said at least one radio frequency identification tag leaves said detection range until a password is entered into said cellular phone.

5. The personal item monitoring system of claim 1, wherein said monitor is a PDA device.

6. The personal item monitoring system of claim 1, wherein said radio frequency identification tag includes an adhesive for adhering to a personal item.

7. The personal item monitoring system of claim 1, wherein said monitor can be temporarily deactivated to cease monitoring said at least one radio frequency identification tag.

8. The personal item monitoring system of claim 1, wherein said detection range is approximately 0.5 to 6.0 meters.

9. The personal item monitoring system of claim 1, wherein said monitor is used to locate said at least one radio frequency identification tag by determining a strength of a returning signal from said radio frequency identification tag.

10. The personal item monitoring system of claim 1, wherein said monitor includes a menu system for listing said at least one radio frequency identification tag.

11. The personal item monitoring system of claim 1, wherein said monitor includes speech recognition capabilities to input the name of a personal item coupled with said at least one radio frequency identification tag.

12. The personal item monitoring system of claim 1, wherein said alert from said monitor includes a synthesized voice identifying a personal item coupled with said at least one radio frequency identification tag.

13. The personal item monitoring system of claim 1, wherein said monitoring system can be temporarily activated or deactivated for said at least one radio frequency identification tag using a clock in said monitor.

14. A personal item monitoring system comprising:
a monitor having a transmitter and a receiver located therein; and
at least one radio frequency identification tag pre-installed into a personal item;
wherein said monitor emits a radio frequency signal received by said radio frequency identification tag, and said radio frequency identification tag emits a responding signal if within a detection range; and
said monitor alerts a user if said at least one radio frequency identification tag leaves said detection range.

15. The personal item monitoring system of claim 14, wherein said monitor is a cellular phone.

16. The personal item monitoring system of claim 15, wherein said cellular phone is programmed to dial a pre-selected phone number to alert said user when said at least one radio frequency identification tag leaves said detection range.

17. The personal item monitoring system of claim 15, wherein said cellular phone is disabled when said at least one radio frequency identification tag leaves said detection range until a password is entered into said cellular phone.

18. The personal item monitoring system of claim 14, wherein said monitor is a PDA device.

19. The personal item monitoring system of claim 14, wherein said monitor can be temporarily deactivated to cease monitoring said at least one radio frequency identification tag.

20. The personal item monitoring system of claim 14, wherein said detection range is approximately 0.5 to 6.0 meters.

21. The personal item monitoring system of claim 14, wherein said monitor is used to locate said at least one radio frequency identification tag by determining a strength of a returning signal from said radio frequency identification tag.

22. The personal item monitoring system of claim 14, wherein said monitor includes a menu system for listing said at least one radio frequency identification tag.

23. The personal item monitoring system of claim 14, wherein said monitor includes speech recognition capabilities to input the name of a personal item coupled with said at least one radio frequency identification tag.

24. The personal item monitoring system of claim 14, wherein said alert from said monitor includes a synthesized voice identifying a personal item coupled with said at least one radio frequency identification tag.

25. The personal item monitoring system of claim 14, wherein said monitoring system can be temporarily activated or deactivated for said at least one radio frequency identification tag using a clock in said monitor.
